(19) United States
(12) Patent Application Publication
(10) Pub. No.: US 2004/0203843 A1
(43) Pub. Date: Oct. 14, 2004

(54) Wireless Phone apparatus having an emergency beacon and method for activation thereof

(75) Inventor: Hamid Najafi, Los Altos Hills, CA (US)

Correspondence Address: SQUIRE, SANDERS & DEMPSEY L.L.P, 600 HANSEN WAY, PALO ALTO, CA, 94304-1043, US

(73) Assignee: CSI Wireless LLC, Milpitas, CA

(21) Appl. No.: 10/099,640

(22) Filed: Mar. 15, 2002

(51) Int. Cl. H04Q 7/20

(52) U.S. Cl. 455/456.1; 455/457

(57) ABSTRACT

A wireless phone includes a SMS engine, communicatively coupled to a wireless transceiver, capable to receive, from a source, a first SMS text message having a first beacon activation command via the transceiver; and a beacon engine, communicatively coupled to the SMS engine and to the transceiver, capable to transmit a beacon via the transceiver upon receipt of the first SMS text message having a beacon activation command.

### TECHNICAL FIELD

This invention relates generally to wireless communications, and more particularly, but not exclusively, provides a wireless phone having an emergency beacon and a method for activation thereof.

### BACKGROUND

When wireless phone users are in need of rescue, such as users trapped in rubble or users lost in the wilderness, it may be hard to locate the users because the users may not know their location or may be unconscious and unable to communicate with rescuers. For example, a wireless phone user may be trapped in a collapsed building caused by an earthquake or terrorist action. Because the user may be pinned immobile beneath rubble or unconscious, the user may not be able to use his or her phone to call rescuers for assistance. In another example, a user may be lost hiking or skiing and can call rescuers for assistance. However, as the user does not know his or her location, the user cannot inform rescuers of his or her location. Accordingly, a new wireless phone is needed to overcome these problems.

### SUMMARY

The present invention provides a wireless phone having an emergency beacon. The phone comprises a wireless transceiver capable to receive and transmit data wirelessly; memory for storing software engines including a short message service (SMS) engine, a beacon engine and an interface; and a processor capable to execute the software engines stored in memory. The SMS engine enables wireless communication of short text messages via the transceiver. In another embodiment of the invention, the SMS engine may transmit and receive data using other data communications or signaling techniques. The beacon engine enables the transmission of an emergency beacon, which can be detected and tracked using a directional antenna or other device, via the transceiver. The beacon engine can begin transmission upon receipt of a beacon command via the SMS engine or on command by a user via the interface.

In an embodiment of the invention, the phone may also include a Global Positioning System (GPS) unit or other location determination device such as a GLONASS receiver. The beacon engine can transmit user location data from the location determination device via a text message using the SMS engine. In an alternative embodiment, the location data may be embedded in a beacon signal that the beacon engine transmits.

The present invention further provides a method for activating a beacon via a SMS message. The method comprises receiving a beacon activation command via SMS or other data communications or signaling techniques; querying a user if he or she wants to begin transmitting a beacon; and if a user enables activation or doesn't respond to the query, transmitting the beacon, which is detectable by a directional antenna. In addition, the method may further comprise: determining if the phone should enter a power save mode if battery voltage drops below a pre-specified level; and if the battery voltage does drop below the pre-specified level then: turning off the receiver in the transceiver and transmitting a beacon per power save parameters. In an embodiment of the invention, the method further comprises receiving location data from a location determination device and transmitting the location data via a SMS message or other data communications or signaling techniques or embedding it in the beacon.

Accordingly, the wireless phone and method advantageously enable transmission of a beacon even when a wireless phone user is incapacitated.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a wireless phone capable to receive a SMS beacon activation command from a command center via a cell site;

FIG. 2 is a block diagram illustrating the wireless phone of FIG. 1;

FIG. 3 is a block diagram illustrating memory of the wireless phone;

FIG. 4 is a block diagram illustrating default parameters stored in the memory of FIG. 3;

FIG. 5 is a block diagram illustrating power save parameters stored in the memory of FIG. 3; and

FIG. 6 is a flowchart illustrating a method for activating a beacon in the wireless phone upon receipt of a beacon activation command.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

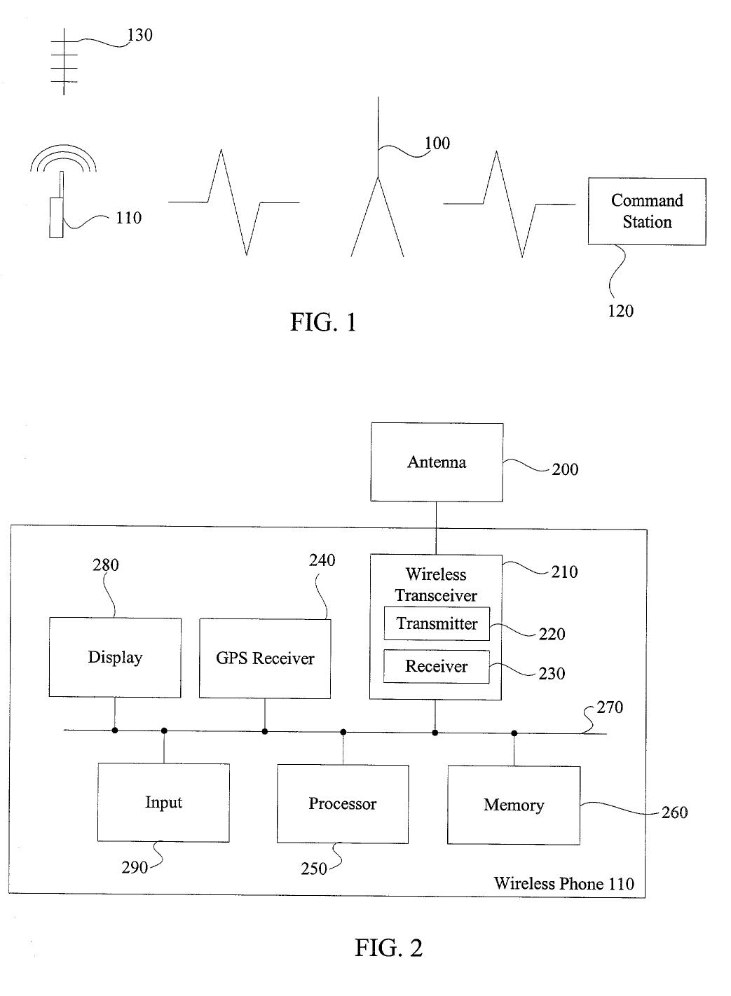

FIG. 1 is a diagram illustrating a wireless phone 110 capable to receive a SMS text message having beacon activation command from a command center 120 via a cell site 100. Alternatively, phone 110 can be activated upon receipt of beacon activation commands from any source and via other data communications or signaling techniques. When phone 110 receives the beacon activation command and begins transmitting a beacon, a directional antenna 130 can be used to track down the phone 110. In an alternative embodiment, the phone 110 also includes a location determination device, such as a GPS receiver. In this embodiment the phone 110 can embed location data from the location determination device into the beacon and/or transmit a SMS message (or other data format) that includes location data.

FIG. 2 is a block diagram illustrating the wireless phone 110 (FIG. 1). Phone 110 includes a wireless transceiver 210 capable to wirelessly communicate with wireless networks via cell sites, such as cell site 100; a memory device 260, such as such as a magnetic disk, Random Access Memory (RAM), Flash Memory or other memory device or combination thereof; a processor 250, such as an ARM 7 microprocessor or a Motorola 68000 microprocessor; optionally, a GPS receiver 240; a display 280; and an input device 290, all interconnected for communication by a system bus 270. In addition, wireless transceiver 210 is communicatively coupled to antenna 200.

GPS receiver 240 receives radio signals from GPS satellites orbiting the Earth. Based on the received signals, the receiver 240 can calculate its position and altitude. The GPS receiver 240 can then forward that data to processor 250 for processing. In an alternative embodiment, a Loran-C radionavigation system receiver, GLONASS, or other location determination system maybe incorporated into phone 110 in place of or in addition to GPS receiver 240.

Transceiver 210 can wirelessly transmit and receive data, including text messages, such as SMS messages or other data formats, and voice, via wireless networks, such as Cellular Digital Packet Data (CDPD) and ARDIS from American Mobile. The transceiver 210 comprises a transmitter 220 for transmitting data and a receiver 230 for receiving data. If the phone 110 is placed into power save mode, as will be discussed in further detail below, the receiver 230 is turned off to conserve battery power.

Processor 250 executes engines stored in memory 260 to transmit and receive SMS text messages (or data in other formats) and to transmit a beacon upon receipt of a beacon activation command from command station 120 or other source. Display 280 comprises a LCD display or other device for displaying data and displays beacon activation warnings and queries, as will be discussed further below. Input 290 includes a keyboard and/or other input device and enables a user to activate a beacon or cancel a beacon activation.

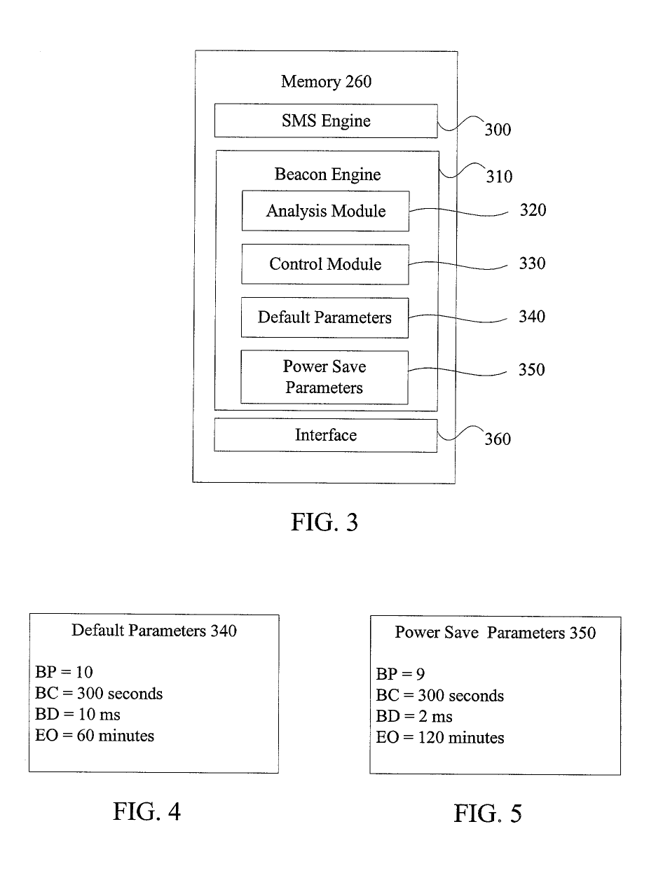

FIG. 3 is a block diagram illustrating memory 260 of the wireless phone 110. Memory 260 comprises a SMS engine 300, a beacon engine 310 and an interface 320. SMS engine 300 enables communication between phone 110 and other SMS enabled devices, such as other phones and command station 120, via short text messages. In an alternative embodiment of the invention, SMS engine 300 is capable of receiving data in a format other than SMS text messages.

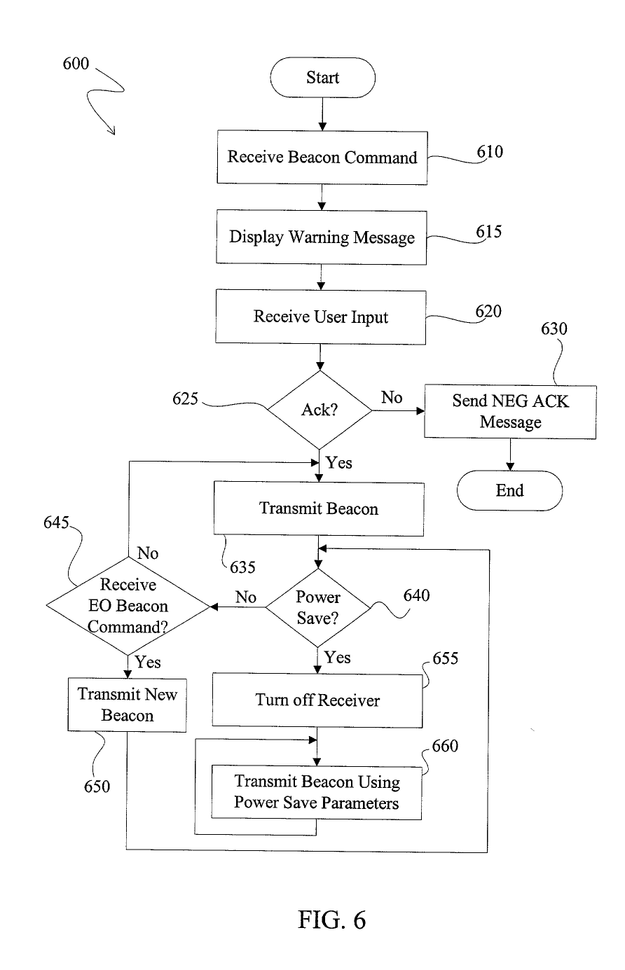

Beacon engine 310 comprises an analysis module 320; a control module 330; default parameters 340; and power save parameters 350. Analysis module 320 analyzes received SMS messages to determine if the messages contain a beacon activation command or beacon Ears On (EO) command, as will be discussed further below in conjunction with FIG. 6. Control module 330 enables transmission of a beacon using transceiver 210 via antenna 200 when the analysis module 320 determines that a beacon activation command has been received. In addition, control module 330 also modifies beacon transmission upon receipt of an EO command, as determined by analysis module 320. The control module 330 also ends beacon transmission upon receipt of beacon deactivation command, as determined by analysis module 320. In addition, control module 330 can initiate beacon transmission upon receipt of beacon activation command from a phone 110 user.

Control module 330 enables beacon transmission based on five parameters including beacon frequency (BF), beacon power (BP), beacon cadence (BC), beacon duration (BD), and ears on (EO) frequency. The beacon may be a single, dual, or tri-frequency sequence of tones selected from the center carrier frequencies of all cellular channels the phone can transmit on. If dual or tri-frequency tones are selected, each carrier frequency is sequentially transmitted for beacon duration (defined below) milliseconds separated by BD milliseconds in a closed loop (BF1, BF2, BF3, BF1, BF2, etc.).

The beacon power level can be any of the power levels available in the phone (PLC0-PLC10, with PLC10 being the minimum). The beacon cadence (repeat frequency) can be selected to be between 1 to 1024 seconds, in one second increments. The duration of each BF signal is determined by BD, wherein BD=1 to 1024 milliseconds and BD<BC*10.

In order for the command station 120 to be able to remotely modify the Beacon parameters of the phone, the phone wakes up and performs a “power up register” once every EO minutes, where EO=1 to 1024. An EO set to 1 means that the phone 110 is always listening for a beacon modification command. In one embodiment, the phone 110 listens for 3 minutes to receive commands, if any, from the command station 120 or other source. Ears On Mode is always activated to allow the command station 120 to remotely deactivate the Beacon, if necessary, to avoid unwanted interference with the cellular system. For this reason, the user cannot change the EO parameter.

Default parameters 340, as will be discussed in further detail in conjunction with FIG. 4, stores parameters for beacon transmission if no parameters are included in a beacon activation command. Power save parameters 350, as will be discussed in further detail in conjunction with FIG. 5, stores parameters for beacon transmission if battery voltage drops below a predefined level.

Interface 360 enables interaction between control module 330 and a phone 110 user. Specifically, upon receipt of a beacon activation command, interface 360 first displays a message on display 280 informing the user that a SMS beacon activation command has been received. The user can then affirm activation or cancel activation via input 290. In addition, the interface 360 enables the user to activate the beacon without the receipt of a SMS beacon activation command.

FIG. 4 is a block diagram illustrating default parameters 340 stored in the memory 260 (FIG. 3). The default parameters specify the parameters for beacon transmission when the user activates the beacon or when a beacon activation command that does not specify parameters is received. The default parameters 340 include setting the beacon power level BP to 10 (maximum); setting the beacon cadence BC to 300 seconds; setting the beacon duration BD to 10 milliseconds; and setting an Ears On parameter EO to 60 minutes. In addition, the beacon frequency, BF, in default mode is determined by performing a control channel scan and setting the BF to a single frequency centered on the first unused transmit channel in the vicinity where the phone 110 is operating. This minimizes potential interference with the cellular system normal operation.

FIG. 5 is a block diagram illustrating power save parameters 350 stored in the memory 260 (FIG. 3). Power save parameters 350 are used whenever battery voltage drops below a pre-specified level, such as 3.2V. Alternatively, the pre-specified level is whatever voltage level sets off a low battery level chime in phone 110. During power save mode, beacon frequencies are not changed. However, as indicated in power save parameters 350, beacon power BP is reduced to 9, beacon cadence BC remains unchanged, beacon duration BD is reduced to 2 milliseconds, and EO is increased to once every 120 minutes. In addition, the receiver 230 may be powered down.

FIG. 6 is a flowchart illustrating a method 600 for activating a beacon in the wireless phone 110 upon receipt of a beacon activation command. First, SMS engine 300 of phone 110 receives (610), from command station 120, cellular base station, or other source, such as a rescue service, a SMS message determined by analysis module 320 to be a beacon command. The SMS message that sets the beacon mode, and specifies its parameters, is unique so as to minimize the possibility of triggering this mode inadvertently by another SMS message. The format of the data portion of the SMS message (ACTIVATION MESSAGE) is given below in ASCII:

% 1$9#5(4(8( )zqw % *( )p!qHnQ&+T: [symbol] 1,BF2,BF3,Qq, [symbol] ,Qq, [symbol] ,Qq, [symbol] ,Qq, [symbol] , [symbol] 1,OP2,0P3] % 1$9

wherein the parameters (shown in [symbol] print) are: BF1, BF2, BF3 are each between 1 to 1999 to specify the channel numbers in the cellular and PCS bands; BP is 0-10; BC is 1 to 1024; EO is 1 to 1024; BD is 1 to 1024 but less than BC*10; and OP1 thru OP3 are optional parameters of variable length.

Alternatively to receiving (610) a SMS message to activate the beacon, a user can manually turn on the beacon via entering a command via input 290 to interface 360. After receiving (610) the beacon command, interface 360 displays (615) a warning message on display 280 such as “WARNING!! Disable phone and activate emergency beacon?” Interface 360 then receives (620) user input via input 290 specifying whether to activate the beacon. If the user input specifies not to activate the beacon, then control module 330, via SMS engine 300, sends (630) a negative acknowledgement message to the sender of the beacon command. The method 600 then ends.

If interface 360 receives (620) user input that specifies to activate the beacon, or if there is no response from the user for a pre-specified amount of time, such as 15 seconds, then control module 330 will transmit (635), via wireless transceiver 210, the beacon according to parameters specified in the beacon command. If no parameters were specified in the SMS message, then control module 330 uses default parameters 340. If only a subset of the parameters were specified in the SMS message, then control module 330 uses the default parameters 340 for the unspecified parameters. If phone 110 includes GPS receiver 240 or other location determination device, the determined location can be embedded in the beacon. Alternatively, or in addition, the determined location can be transmitted to command station 120 via SMS message.

After transmission (635), control module 330 determines (640) if phone 110 should enter a power save mode. Control module 330 can make this determination based on battery voltage falling below a certain level. If control module 330 determines that phone 110 should enter power save mode, then control module 330 turns off receiver 230 and begins transmitting a beacon per power save parameters 350. In an embodiment of the invention, control module 330 turns on receiver 230 once every 120 minutes (per power save parameters 350) to listen for new beacon commands.

If control module 330 determines (640) not to enter power save mode, then control module 330 determines if a new beacon command has been received (645). If a new beacon command has been received, then control module 330 transmits (650) the beacon per the new command. Otherwise, control module 330 transmits (635) the beacon per the original command.

One of ordinary skill in the art will recognize that actions performed in method 600 may be performed in different order than the order described above. For example, determining (640) to enter power save mode may be done continuously during the execution of method 600. Further, determining if an EO beacon command has been received may also be done continuously or at specific time intervals according to received parameters, default parameters 340 or power save parameters 350.

In an embodiment of the invention, method 600 can be halted by a user deactivating beacon transmission via entering a command via input 290 to interface 360 or by receiving a beacon command having all parameters set to 0.

The foregoing description of the illustrated embodiments of the present invention is by way of example only, and other variations and modifications of the above-described embodiments and methods are possible in light of the foregoing teaching. For example, other data communications or signaling techniques besides SMS may be used for transmitting beacon activation commands and/or location information. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method to be performed in a wireless phone, comprising:
receiving, from a source, a first message having a first beacon activation command; and
activating a beacon per the command.

2. The method of claim 1, further comprising embedding location information into the beacon.

3. The method of claim 1, further comprising sending a message having location information to the source.

4. The method of claim 1, further comprising displaying a warning message of pending beacon activation.

5. The method of claim 1, wherein the first beacon activation command includes beacon parameters.

6. The method of claim 5, further comprising receiving a second message having a second beacon activation command, the second beacon activation command having different parameters than the first beacon activation command.

7. The method of claim 6, wherein the beacon parameters include beacon power, beacon cadence, beacon duration.

8. The method of claim 1, wherein activating uses default beacon parameters if the beacon activation command does not include parameters.

9. The method of claim 1, further comprising:
determining to enter a power save mode; and
if it is determined to enter the power save mode then turning off a receiver in the wireless phone, and activating the beacon per power save beacon parameters.

10. The method of claim 1, wherein the first message includes a SMS text message.

11. A wireless phone, comprising:
means for receiving, from a source, a first message having a first beacon activation command; and
means for activating a beacon per the command.

12. A computer-readable medium for storing instructions to cause a wireless phone to perform a method, the method comprising:
receiving, from a source, a first message having a first beacon activation command; and
activating a beacon per the command.

13. The computer-readable medium of claim 12, the method further comprising embedding location information into the beacon.

14. The computer-readable medium of claim 12, the method further comprising sending a message having location information to the source.

15. The computer-readable medium of claim 12, the method further comprising displaying a warning message of pending beacon activation.

16. The computer-readable medium of claim 12, wherein the first beacon activation command includes beacon parameters.

17. The computer-readable medium of claim 16, the method further comprising receiving a second message having a second beacon activation command, the second beacon activation command having different parameters than the first beacon activation command.

18. The computer-readable medium of claim 17, wherein the beacon parameters include beacon power, beacon cadence, beacon duration.

19. The computer-readable medium of claim 12, wherein the activating uses default beacon parameters if the beacon activation command does not include parameters.

20. The computer-readable medium of claim 12, the method further comprising:
determining to enter a power save mode; and
if it is determined to enter the power save mode then turning off a receiver in the wireless phone, and activating the beacon per power save beacon parameters.

21. The computer-readable medium of claim 12, wherein the first message includes a SMS text message.

22. A wireless phone, comprising:
a communications engine, communicatively coupled to a wireless transceiver, capable to receive, from a source, a first message having a first beacon activation command via the transceiver; and
a beacon engine, communicatively coupled to the communications engine and to the transceiver, capable to transmit a beacon via the transceiver upon receipt of the first message having a beacon activation command.

23. The phone of claim 22, further comprising a location determining device communicatively coupled to the beacon engine, and wherein the beacon engine is further capable to embed location information into the beacon.

24. The phone of claim 22, further comprising a location determining device communicatively coupled to the beacon engine, and wherein the beacon engine is further capable to send a mess age having location information to the source.

25. The phone of claim 22, further comprising an interface engine, communicatively coupled to the communications engine, capable to display a warning message of pending beacon activation.

26. The phone of claim 22, wherein the first beacon activation command includes beacon parameters and wherein the beacon engine transmits the beacon according to the beacon parameters.

27. The phone of claim 26, wherein the communications engine is further capable to receive a second message having a second beacon activation command, the second beacon activation command having different parameters than the first beacon activation command, and wherein the beacon engine is further capable to transmit the beacon according to the beacon parameters of the second beacon activation command.

28. The phone of claim 27, wherein the beacon parameters include beacon power, beacon cadence, beacon duration.

29. The phone of claim 22, wherein the beacon engine uses default beacon parameters if the beacon activation command does not include parameters.

30. The phone of claim 22, wherein the beacon engine is further cable to:
determine to enter a power save mode; and
if it is determined to enter the power save mode then to turn off a receiver in the transceiver, and transmit the beacon per power save beacon parameters.

31. The phone of claim 22, wherein the first message includes a SMS text message.
